(19) United States
(12) Patent Application Publication
(10) Pub. No.: US 2015/0124965 A1
(43) Pub. Date: May 7, 2015

(54) Document With Verification Data

(71) Applicant: MASTERCARD INTERNATIONAL INCORPORATED, Purchase, NY (US)

(72) Inventors: James C. Noe, Kent (GB); Michael J. Cowen, London (GB)

(21) Appl. No.: 14/532,498

(22) Filed: Nov. 4, 2014

(30) Foreign Application Priority Data
Nov. 5, 2013 (GB) 1319552.4

(51) Int. Cl. H04N 1/44; H04L 9/32

(52) U.S. Cl. CPC H04N 1/4486; H04L 9/3263
USPC 380/243

(57) ABSTRACT

Disclosed herein is a method of generating a document comprising verification data, the method comprising: obtaining data for inclusion on a document, wherein the obtained data includes verification data; encrypting the verification data; generating a machine readable code comprising the encrypted verification data; and generating a document comprising both the obtained data in a non-encrypted form and the machine readable code. Advantageously, an entity that is required to verify the document can decrypt the machine readable code to obtain the verification data. The encrypted nature of the data within the machine readable code ensures that the data is secure and the verification reliable.

### FIELD

The present disclosure relates generally to the verification of the details of a document or a person. In particular, but not exclusively, the disclosure concerns the generation of a document that comprises a machine readable code comprising encrypted verification data of the document itself, thereby allowing a third party to independently verify the authenticity of the document. The disclosure further concerns using such a machine readable code to verify the details of a person and the secure reproduction of said document.

### BACKGROUND

This section provides background information related to the present disclosure which is not necessarily prior art.

There are a number of scenarios in which a person is required to verify their identity and/or address by providing one or more documents. For example, a person may be asked to provide a utility bill as proof of their address when opening a new bank account or to produce similar such documents to prove their existence and address to an authority.

FIG. 1 shows an exemplary document that may be used to verify the details of a person. The document is a gas bill and includes data on the name of the person, the type of document, the address of the person, the date that the bill was generated and the amount of the bill. Alternative documents used for verifying the details of a person may be bills from other utility companies, bank statements and any documents from trusted entities that have on them the name and/or address of the person with details that are required to be verified.

Currently, only original hard copy versions of suitable documents are typically accepted by the entity that is required to verify the details of a person. The person therefore has to either present hard copies of the documents in person or the documents have to be sent to the entity by mail.

The above results in the process required to verify a person's details being slow, inconvenient and expensive. There is also the risk that any documents sent by post may be lost. These problems may have the further adverse effect of putting people off applying for services or abandoning applications for services.

Furthermore, due to the high quality of printers that are now widely available, there is a risk that fraudulent documents could be printed containing falsified personal details.

A yet further problem is that hard copies of suitable documents for verification may not be available if the providers of such documents only issue electronic versions of documents, as with, for example, electronic billing. A person may therefore not be provided with hard copies of documents that are suitable for verifying their details.

More generally, there is a need to improve the security of documents themselves.

### SUMMARY

This section provides a general summary of the disclosure, and is not a comprehensive disclosure of its full scope or all of its features.

According to a first aspect of the present disclosure, there is provided a method of generating a document comprising verification data, the method comprising: obtaining data for inclusion on a document, wherein the obtained data includes verification data; encrypting the verification data; generating a machine readable code comprising the encrypted verification data; and generating a document comprising both the obtained data in a non-encrypted form and the machine readable code.

In some embodiments, the method further comprises obtaining the verification data for encrypting by extracting the verification data from obtained data for inclusion in the document in a non-encrypted form.

In some embodiments, the method further comprises transmitting the generated document to an address that is dependent on the verification data in the generated document.

In some embodiments, the verification data is indicative of a person.

In some embodiments, the verification data is one or more of: the identity of a person, the address of a person; the entity that generated the document; the date that the document was generated; financial data located within the document; data relating to the document itself; and any data element of the document.

In some embodiments, the method further comprises including data identifying the source of a public key for decrypting data encrypted by a private key in the machine readable code.

In some embodiments, the machine readable code is a barcode such as a 2D barcode, for example a QR code.

In some embodiments, the method comprises transmitting an electronic version of the generated document by email or via a web portal.

In some embodiments, the generated document is a physical document, and the method comprises transmitting the generated document by sending the document using a mail delivery service or by facsimile.

According to a second aspect of the present disclosure, there is provided a method for obtaining verification data by a verifying entity, the method comprising the verifying entity: receiving a machine readable code, wherein the machine readable code comprises encrypted verification data; reading the machine readable code to obtain the encrypted data; and decrypting the encrypted data to obtain verification data.

In some embodiments, the verification data is indicative of a person.

In some embodiments, the method further comprises the verifying entity verifying the person in dependence on the obtained verification data.

In some embodiments, the method further comprises the verifying entity sending a request for the verification data.

In some embodiments, the machine readable code comprises data identifying a source, optionally a certification authority, of a public key, optionally a signed public key, for decrypting the encrypted data, and the method further comprises the verifying entity retrieving the public key.

In some embodiments, the machine readable code is comprised by a document and the method further comprises verifying the document in dependence on the verification data.

In some embodiments, the machine readable code is generated in accordance with the machine readable code generated according to any of the above-described methods.

In some embodiments, the method further comprises receiving the machine readable code in an electronic form.

In some embodiments, the method further comprises extracting the machine readable code from a received electronic version of a document comprising the machine readable code.

According to a third aspect of the present disclosure there is provided a method of providing verification data to a verifying entity, the method comprising: sending a machine readable code to a verifying entity; wherein the machine readable code is a machine readable code comprised in a document.

In some embodiments, the machine readable code is comprised in a document generated according to any of the above-described methods.

In some embodiments, the step of sending a machine readable code to the verifying entity comprises sending an electronic version of the document.

In some embodiments, the method further comprises obtaining an image of the machine readable code on the document; wherein the step of sending the machine readable code to the verifying entity comprises sending the obtained image of the machine readable code.

In some embodiments, said step of sending a machine readable code occurs in response to receiving a request for verification data from the verifying entity.

In some embodiments, the verification data is of a person.

According to a fourth aspect of the present disclosure there is provided a method in a system comprising a verifying entity and a device for providing verification data, wherein: the verifying entity performs any of the above-described methods and the device for providing verification data performs any of the above-described methods.

According to a fifth aspect of the present disclosure, there is provided a document comprising a machine readable code that is generated according to any of the above-described methods.

According to a sixth aspect of the present disclosure, there is provided a verifying entity configured to perform any of the above-described methods.

According to a seventh aspect of the present disclosure, there is provided a device for providing verification data that is configured to perform any of the above-described methods.

According to an eighth aspect of the present disclosure, there is provided a system comprising a verifying entity and a device for providing verification data configured to perform any of the above-described methods.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. Embodiments of the present disclosure will be described, by way of example only, with reference to the accompanying drawings, in which:

FIG. 1 shows a representation of the front face of a known form of utility bill;

FIG. 2 shows verification data, corresponding to data on an exemplary utility bill, for including in a machine readable code according to an embodiment of the disclosure;

FIG. 3 shows a document comprising a machine readable code according to an embodiment of the disclosure;

FIG. 4 shows the steps of a process according to an embodiment of the disclosure;

FIG. 5 shows the steps of a process according to an embodiment of the disclosure; and

FIG. 6 shows the steps of a process according to an embodiment of the disclosure.

Corresponding reference numerals indicate corresponding parts throughout the several views of the drawings.

### DETAILED DESCRIPTION

Specific embodiments of the present disclosure will be described below with reference to the Figures. The description and specific examples included herein are intended for purposes of illustration only and are not intended to limit the scope of the present disclosure.

The embodiments are described with the verification data being data indicative of a person. Although this is an exemplary implementation, embodiments also include the verification data being of the document itself only, and not of a person.

According to the present disclosure, documents suitable for verifying the details of a person are generated with a machine readable code, such as a barcode or 2D barcode, that comprises verification data for verifying the person. The same verification data can be obtained both by someone reading the document itself and by a machine from the machine readable code. The machine readable code stores the verification data in an encrypted form.

Advantageously, verification data for verifying the details of a person is provided by the machine readable code and the entity that is required to verify the details of the person can decrypt the machine readable code to obtain the verification data. It is therefore not necessary for hard copies of the documents for verifying the details of a person to ever be generated, so long as the document, which may exist in an electronic form only, comprises a machine readable code that can be provided for verification. In addition, the encrypted nature of the data within the machine readable code ensures that the data is secure and the verification reliable. This technique ensures that the data read from the machine readable code has not been tampered with and has originated from a known source.

Techniques for using such machine readable codes to verify the details of a person will be described in more detail below.

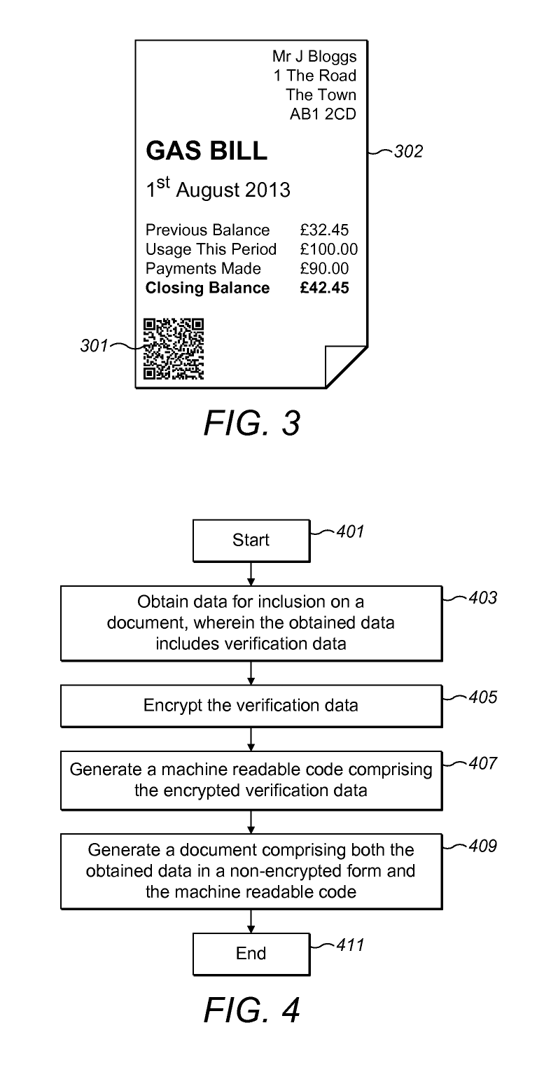

A document comprising an exemplary machine readable code is described below with reference to FIGS. 2 and 3.

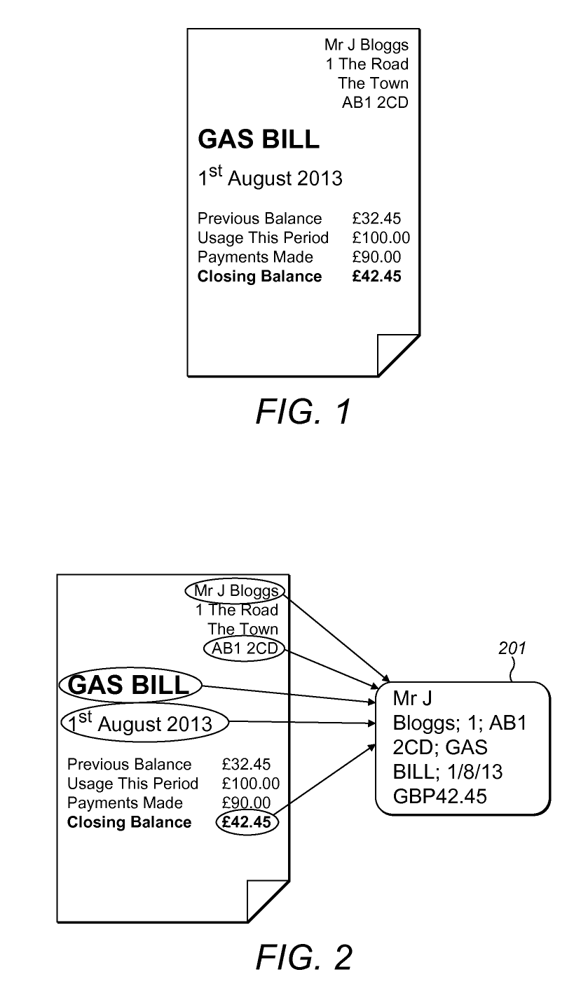

Verification data 201, for inclusion in a machine readable code 301, is first obtained. FIG. 2 shows how the verification data 201 may correspond to the data that is already included on the exemplary gas bill of FIG. 1. The verification data 201 may include the person's name, address, the type of bill, the date that the bill was generated and the amount of the bill.

The verification data 201 is then encrypted. For example, the verification data 201 is encrypted using a private key in a conventional public/private key encryption mechanism. The private key is signed by a certification authority, CA.

A machine readable code 301 is then generated that comprises the encrypted verification data 201. The machine readable code 301 may also comprise further data, such as a digital signature and data for identifying the source of the public key for decoding the encrypted data so that the public key can be retrieved by any entity that needs to decrypt the verification data 201. The further data would not be encrypted.

The machine readable code 301 may be any form of machine readable code 301 including a barcode or a 2D barcode. For example, the machine readable code 301 is a 2D barcode, such as a QR code, because 2D barcodes have a larger data capacity.

A document 302 is then generated, as shown in FIG. 3, that includes verification data 201 present in a non-encrypted form as well as the machine readable code 301 comprising the encrypted verification data 201.

The document 302 may be created as a hard copy for mailing to an intended recipient and/or it may be generated as an electronic document 302, such as a PDF, and sent to the recipient by, for example, email or via a web portal.

In the above described embodiment, the verification data 201 for including in the machine readable code 301 may be retrieved and/or prepared independently of the verification data 201 for inclusion in the document 302 in a non-encrypted form. In an alternative to the above-described embodiment, the verification data 201 for including in a document 302 in a non-encrypted form is first retrieved and/or prepared. The data may be prepared as shown for creating the document shown in FIG. 1. The verification data 201 for including in the machine readable code 301 is then obtained by extracting the verification data 201 from the data already prepared for creating the document. A machine readable code 301 comprising the data in an encrypted form is then created and included on the document 302, as previously described above, to create an electronic and/or hard copy of a document 302 comprising a machine readable code 301, as shown, for example, in FIG. 3.

A method of generating a document 302 including a machine readable code 301 is described below with reference to FIG. 4.

In step 401, the process begins.

In step 403, data for inclusion on a document 302 is obtained, wherein the obtained data includes verification data 201.

In step 405, the verification data 201 is encrypted.

In step 407 a machine readable code 301 comprising the encrypted data is generated. The machine readable code 301 may contain additional data such as a digital signature.

In step 409, a document 302 comprising both the obtained data in a non-encrypted form and the machine readable code 301 is generated.

In step 411, the process ends.

According to the above-described embodiments, an electronic and/or hard copy of a document 302 is created with a secure machine readable code 301 comprising verification data 201. Advantageously, the details of the person who is the subject of the verification data 201 can potentially be verified by solely providing the machine readable code 301. The machine readable code 301 can be provided in an electronic form and it is not necessary for a hard copy of a document 302 to be generated or provided to an entity that wishes to verify the details of the person. Alternatively, the party wishing to authenticate the individual may do so by the individual simply scanning the machine readable code with, for example, a mobile phone's camera or a web cam and the resulting scanned data being sent directly to the party wishing to perform the authentication.

According to a further embodiment, the identity of a person is verified using a machine readable code 301 that has been generated according to any of the above-described embodiments.

A verifying entity requires verification data 201 of a person. The verifying entity may be, for example, a bank that has been asked to open an account for a new customer, or an authority that wants to verify the claimed address of a person.

The verifying entity sends a request for verification data 201 to the person that they want to verify the details of.

In some embodiments, in response to receiving the request, the person responds by providing the verifying entity with the machine readable code 301 generated as described above. This may be, for example, by scanning the machine readable code with a mobile phone's camera, by emailing a PDF, by faxing a copy of the document or by sending a photocopy or print out of the original document to the receiving party.

Although it is described that a request for verification data 201 is sent by the verifying entity, this is not essential and the person may provide the machine readable code 301 to the verifying entity without a request ever being made.

The person may transmit an electronic version of the machine readable code 301 to the verifying entity. The electronic version may be comprised within an electronic version of a document 302, such as a PDF, comprising the machine readable code 301 and the entire document 302 may be sent to the verifying entity. Alternatively, the person may obtain an image of the machine readable code 301 on a document 302; by, for example, taking a picture with a mobile telephone camera or a web cam, and send the obtained image to the verifying entity.

The verifying entity receives the machine readable code 301. The verifying entity then decrypts the encrypted verification data 201 comprised by the machine readable code 301 to obtain the verification data 201 of the person.

The verifying entity may obtain the public key for decrypting the encrypted data by first determining the source of the public key from unencrypted data within the machine readable code 301 and then retrieving the required public key from the source. In an exemplary implementation, a signed public key for decrypting the encrypted data within the machine readable code 301 is obtained from a CA.

The verifying entity then verifies the details of the person in dependence on the decrypted verification data 201.

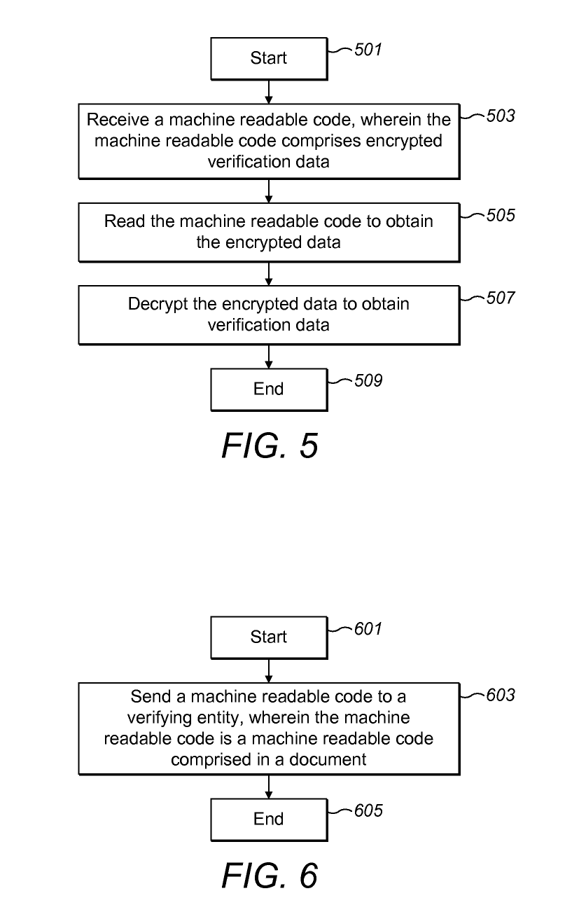

A method of securely obtaining verification data 201 of a person is described below with reference to FIG. 5.

In step 501, the process begins.

In step 503, a machine readable code 301 is received, wherein the machine readable code 301 comprises encrypted verification data 201.

In step 505, the machine readable code 301 is read to obtain the encrypted data.

In step 507, the encrypted data is decrypted to obtain verification data 201.

In step 509 the process ends.

A method of providing verification data 201 to a verifying entity is described below with reference to FIG. 6.

In step 601, the process begins.

In step 603, a machine readable code 301 is sent to a verifying entity, wherein the machine readable code 301 is a machine readable code 301 comprised in a document.

In step 605, the process ends.

Advantageously, according to the above-described embodiment, a verifying entity is able to verify the details of a person using only a machine readable code 301. The machine readable code 301 may be electronically transmitted to the verifying entity and it is not necessary for a hard copy of a document 302 for verifying the details of a person to be generated or presented.

Further advantageously, the security of the data provided by a document 302 is improved since the verification data 201 within the machine readable code 301 is encrypted and cannot therefore be tampered with.

Described throughout the present document are communications between a verifying entity, a CA and a person. These communications can be performed by any type of communication system or device of the verifying entity, the CA and the person, including computers and mobile terminals.

It should be appreciated that the functions described herein, in some embodiments, may be described in computer executable instructions stored on a computer readable media (e.g., in a physical, tangible memory, etc.), and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

Further, the flow charts and descriptions thereof herein should not be understood to prescribe a fixed order of performing the method steps described therein. Rather, the method steps may be performed in any order that is practicable. Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of generating a document comprising verification data, the method comprising:
obtaining data for inclusion on a document, wherein the obtained data includes verification data;
encrypting the verification data;
generating a machine readable code comprising the encrypted verification data; and
generating a document comprising both the obtained data in a non-encrypted form and the machine readable code.

2. The method according to claim 1, further comprising obtaining the verification data for encrypting by extracting the verification data from obtained data for inclusion in the document in a non-encrypted form.

3. The method according to claim 1, further comprising transmitting the generated document to an address that is dependent on the verification data in the generated document.

4. The method according to claim 1, wherein the verification data is indicative of a person.

5. The method according to claim 1, wherein the verification data is one or more of: the identity of a person, the address of a person; the entity that generated the document; the date that the document was generated; financial data located within the document; data relating to the document itself; and any data element of the document.

6. The method according to claim 1, further comprising including data identifying the source of a public key for decrypting data encrypted by a private key in the machine readable code.

7. The method according to claim 1, wherein the machine readable code is a barcode, preferably a 2D barcode, for example a QR code.

8. The method according to claim 3, wherein the method comprises transmitting an electronic version of the generated document by email or via a web portal.

9. The method according to claim 3, wherein the generated document is a physical document, and the method comprises transmitting the generated document by sending the document using a mail delivery service or by facsimile.

10. A method for obtaining verification data by a verifying entity, the method comprising:
receiving a machine readable code, wherein the machine readable code comprises encrypted verification data;
reading, by the verifying entity, the machine readable code to obtain the encrypted data; and
decrypting, by the verifying entity, the encrypted data to obtain verification data.

11. The method according to claim 10, wherein the verification data is indicative of a person.

12. The method according to claim 11, further comprising verifying the person in dependence on the obtained verification data.

13. The method according to claim 10, further comprising sending, by the verifying entity, a request for the verification data.

14. The method according to claim 10, wherein the machine readable code comprises data identifying a source of a public key for decrypting the encrypted data, and the method further comprises retrieving, by the verifying entity, the public key.

15. The method according to claim 10, wherein the machine readable code is comprised by a document and the method further comprises verifying the document in dependence on the verification data.

16. (canceled)

17. (canceled)

18. The method according to claim 17, further comprising extracting the machine readable code from a received electronic version of a document comprising the machine readable code.

19. A method of providing verification data to a verifying entity, the method comprising:
sending a machine readable code to a verifying entity;
wherein the machine readable code is a machine readable code comprised in a document.

20. (canceled)

21. The method according to claim 19, wherein the step of sending a machine readable code to the verifying entity comprises sending an electronic version of the document.

22. The method according to claim 19, further comprising obtaining an image of the machine readable code on the document;
wherein the step of sending the machine readable code to the verifying entity comprises sending the obtained image of the machine readable code.

23. The method according to claim 19, wherein said step of sending a machine readable code occurs in response to receiving a request for verification data from the verifying entity.

24.-29. (canceled)
